(19) United States
(12) Patent Application Publication
(10) Pub. No.: US 2022/0406112 A1
(43) Pub. Date: Dec. 22, 2022

(54) Handle Arrangement with User Authentication

(71) Applicant: Industrilås i Nässjö Aktiebolag, Nässjö (SE)

(72) Inventor: Johan Calleberg, Billdal (SE)

(21) Appl. No.: 17/772,162

(22) PCT Filed: Nov. 5, 2020
(86) PCT No.: PCT/EP2020/081121

§ 371 Date: Apr. 27, 2022

(30) Foreign Application Priority Data
Nov. 6, 2019 (EP) 19207425.0

(51) Int. Cl. G07C 9/23; G07C 9/27; G07C 9/00; E05B 1/00; E05B 17/22

(52) U.S. Cl. CPC G07C 9/23; G07C 9/27; G07C 9/00698; E05B 1/0084; E05B 17/226; G07C 2209/08

(57) ABSTRACT

The present invention relates to a handle arrangement (1) comprising a locking mechanism (10), a blocking mechanism (20), a handle (30), a display unit (50), and a control unit (40) communicatively connected to a remote server (80) and configured to display a QR code on the display unit for a user to read, wherein the QR code is unique for the handle arrangement and the time period during which the QR code is displayed, receive, from a remote server, information that the user has communicated, to the remote server, a reading of the displayed QR code together with an identification of the user, and that the identified user is authorized to open the door, and either operate the blocking mechanism enabling opening of the door by means of the handle, or enabling a second level authorization function for the user to verify its authorization, and if access is granted, operating the blocking mechanism enabling opening of the door by means of the handle.

### TECHNICAL FIELD

The present disclosure relates to a handle arrangement, and especially to a handle arrangement with a user authentication function.

### BACKGROUND

In large buildings, systems for authorization management for different areas, rooms, doors, windows, spaces etc. may be very complex. Besides using traditional key cards for user, which key cards are used to give access for users to different areas, passive tags, such as RFID tags, may be used by user to identify themselves, and be granted access to an area. However, in situations involving many users and many different areas to which different users may have access, a solution involving user items such as key cards or tags may require many user items and a high level of administration, incurring large costs. Further, a system involving such user items is not flexible when it comes to temporary access to visitors, since a special physical item is needed.

Consequently, there is a need for an arrangement of providing users access to different areas of a building, which is cost effective, secure and flexible to manage.

### SUMMARY

It is an object of the present invention to provide an improved solution that alleviates the mentioned drawbacks with present devices. Furthermore, it is an object to provide an arrangement which provides a high level of security at the same time as being flexible both for the user and the management.

The invention is defined by the appended independent claims, with embodiments being set forth in the appended dependent claims, in the following description and in the drawings.

According to a first aspect of the present invention, a handle arrangement for arrangement on a door, window, gate or hatch openable relative a frame is provided. The handle arrangement comprises a locking mechanism configured to provide, in a locking state, a locking the door, window, gate or hatch to the frame, a blocking mechanism configured to, in a blocking state, prevent the locking mechanism to be moved from the locking state, a handle operative by a user and configured to, when operated, move the locking mechanism from the locking state, a control unit communicatively connected to a remote server and capable of controlling the blocking mechanism, and a display unit controlled by the control unit and configured to display information to a user. The control unit is configured to display a QR code on the display unit for a user to read by means of a mobile device capable of reading a QR code, wherein the QR code is unique for the handle arrangement and the time period during which the QR code is displayed, receive, from a remote server, information that the user has communicated, to the remote server, a reading of the displayed QR code together with an identification of the user, and that the identified user is authorized to open the door, window, gate or hatch, and in response to the received information from the remote server, enable a second level authorization function for the user to verify its authorization, and if access is granted, operate the blocking mechanism from the blocking state to an unblocking state, thereby enabling opening of the door, window, gate or hatch by means of the handle.

The handle arrangement according to the present invention may thereby provide an arrangement that is cost-efficient, secure and flexible when providing an authentication solution for a door, window, gate or hatch. The control unit may have a wireless connection to the remote server. In case of a door, the handle arrangement may be a door handle arrangement arranged on a door openable relative a door frame. Similarly, the handle arrangement may be arranged on a window openable relative a window frame, on a gate openable relative a gate frame, or on a hatch openable relative a surrounding hatch frame. The use of the handle arrangement on a hatch may provide a management of access to spaces to which only authorized personal should have access, such as service spaces in industrial equipment or machinery. In either embodiment, the locking mechanism of the handle arrangement may provide, in a locking state, a locking of the door, window, gate or hatch to the corresponding frame, or may interact with a lock provided on the door, window, gate or hatch to provide a locking thereof.

The QR code may comprise information unique for the specific individual handle arrangement, thereby identifying a specific door, window, gate or hatch which the user intends to open. In a building comprising a large number of doors, window, gate or hatch, a handle arrangement as presented herein may be provided on each door, window, gate or hatch. The user may thereby identify which door, window, gate or hatch is intended to be opened by reading the QR code and communicate such information to the remote server. The QR code may further be unique for a predetermined time period. The reading of the displayed QR code may thereby only be valid for an authorization procedure during a limit time period.

The time period may be a predetermined time period of for instance 5 seconds, 10 seconds or 30 seconds. After said time period, a new QR code may be generated valid for a new time period. By providing a QR code unique for a time period, it may be prevented that a user saves an old QR code to use for authentication, thereby preventing unauthorized access to the door, window, gate or hatch.

The information received by the control unit from the remote server may indicate that a user that has read the QR code has communicated the reading together with an identification of the user, and that the identified user is authorized to open the door, window, gate or hatch. The information may be provided by a message indicating that the door, window, gate or hatch should be opened, or that a second level authorization function should be enabled, implicitly providing that the user has been granted access.

In response to the received information, the control unit may either directly operate the blocking mechanism to unlock the door, window, gate or hatch, or enable the second authorization function for the user. In the latter case, the information received by the control unit from the remote server may further comprise information relevant for the second level authorization function. When the user has been granted access, the control unit may operate the blocking mechanism to unlock the door, window, gate or hatch.

In the embodiment of enabling a second level authorization function, an extended security function may be provided. For the user to access the door, window, gate or hatch, the correct read QR code and identification need to be provided to the remote server, as well as verifying the authorization in a second level. An improved prevention for unauthorized access may thereby be provided. By enabling the second level authorization function, it may be meant that said function is activated, that information is provided to the user that enables a verification, or the like.

In one embodiment, the step of enabling a second level authorization function may comprise displaying a keypad on the display unit for the user to enter a pin code, and when the correct pin code is entered, operating the blocking mechanism from the blocking state to an unblocking state, thereby enabling opening of the door, window, gate or hatch by means of the handle.

The control unit may be configured to, as a response to the information from the remote server that the identified user is authorized to open the door, window, gate or hatch, display a keypad on the display unit. The user may then enter a correct pin code on the keypad to verify the authorization. The pin code may for instance been received by the user via a message to the mobile device from the remote server. Once the correct pin code has been entered, the control unit may unlock the door, window, gate or hatch.

In one embodiment, the handle arrangement may further comprise a tag reader, and the step of enabling a second level authorization function may comprise the step of the control unit activating the tag reader, and when tag is read authorizing the user, operating the blocking mechanism from the blocking state to an unblocking state, thereby enabling opening of the door, window, gate or hatch by means of the handle.

The tag reader may for instance be a RFID reader, or other type of NFC reader. The second level authorization function involving a tag reader may then require the user to have a physical tag providing verification of authorization to the door, window, gate or hatch. However, together with the initial authorization procedure with the QR code, only access to the tag is not enough. Together, the two functions provide a higher level of security to the authorization procedure. The tag reader may be integrated in the handle arrangement, and/or integrated in the control unit. Before the first level of authorization using the QR code is granted, i.e. before the control unit has received information from the remote server that the user has been identified to be authorized to open the door, window, gate or hatch, the tag reader may be disable. The control unit may activate the tag reader only after said first level authorization is granted. In an embodiment the handle arrangement may comprise a housing in which the display unit is integrated, the tag reader may further be integrated in the housing.

In one embodiment, the QR code may be generated on the remote server, and the control unit may further be configured to receive the QR code from the remote server and then display the received QR code on the display unit.

The control unit may be in recurring communicative contact with the remote server. The control unit may receive information from the remote server regarding when a new QR code should be displayed. The QR code unique for the specific handle arrangement and for the present time period may be generated by the remote server. A new QR code may be generated by the remote server at predetermined intervals, such as every 5 seconds, 10 seconds or 30 seconds. When a new QR code is generated for the specific handle arrangement, the control unit may receive the new QR code from the remote server, and may display it on the display unit. In one embodiment, the control unit may only display the QR code once an initiation of an authorization procedure has been performed.

In one embodiment, the handle arrangement may further comprise a housing in which the blocking mechanism, and the control unit may be mounted, in which the display unit may be integrated, and to which the handle may be arranged.

The housing with integrated display unit, and which holds the control unit and blocking mechanism, may provide a handle arrangement that is easy to use and easy to mount. The installer of the handle arrangement, and the person responsible for installing and managing the door, window, gate or hatch authentication may find it advantageous with a handle arrangement having these parts combined and integrated. Further, for the user, it may provide an intuitive solution to use when performing an authentication to open the door, window, gate or hatch. In an embodiment comprising a tag reader, the tag reader may be mounted inside said housing, integrated in said housing, and/or integrated in the control unit.

In one embodiment, the display unit may be a touch-sensitive display.

By providing a touch-sensitive display, the control unit may adapt the display unit for either displaying a QR code, or display a keypad and receiving input on the keypad from the user to identify the pin code. A compact handle arrangement may thereby be provided.

In one embodiment, the control unit may be configured to display the QR code on the display unit as a response to an initiation of an authorization procedure.

The control unit may thereby not display the QR code unless there is a user present that wants access to the door, window, gate or hatch. The user may initiate the authorization procedure by initiating the control unit to display the QR code. If the display unit is a touch-sensitive display, the initiation may be provided by the user touching the display unit. Alternatively, the handle arrangement may comprise a separate button for initiating the control unit to display the QR code. In one embodiment, the initiation may provide the control unit to display an already generated QR code received from the remote server or generated by the control unit. Alternatively, the initiation may provide the control unit to generate a new QR code or request a new QR code to be generated and returned by the remote server, which is then displayed.

In one embodiment, the blocking mechanism may further comprise an electric motor configured to operate the blocking mechanism between the blocking state and the unblocking state, and the control unit may be configured to control the electric motor to operate the blocking mechanism.

The electric motor may be part of the blocking mechanism mounted in a housing of the handle arrangement. The blocking mechanism being operated by the electric motor may provide that the control unit may control the state of the blocking mechanism as a response to the authorization of the user. The state of the blocking mechanism then provides the enablement of the user to open the door, window, gate or hatch.

In one embodiment, the QR code which the control unit is configured to display on the display unit may be valid during a predetermined time period, and after said predetermined time period, the control unit may be configured to either stop the displaying of the QR code, or to replace the QR code with a new QR code that may be valid for authorization of a user during a new time period starting from the displaying of the new QR code.

If the QR code is displayed as a response to an initiation of an authorization procedure, the control unit may stop the displaying of the QR code after a predetermined time. A new generated QR code may then be displayed when a new initiation of an authorization procedure is received. If QR codes are constantly displayed on the display unit, a new generated QR code may be displayed after the predetermined time period.

According to a second aspect of the present invention, a method of opening a door, window, gate or hatch provided with a handle arrangement according to any of the embodiments above may be provided. The method comprises the steps of reading a QR code displayed on the display unit of the handle arrangement by means of a mobile device capable of reading a QR code, communicating the read QR code to a remote server together with identification data of the user, and opening the door, window, gate or hatch after the remote server has verified that the identified user is authorized to open the door, window, gate or hatch, such that the blocking mechanism is operated from the blocking state to an unblocking state. The embodiments of the handle arrangement presented above is equally applicable to the method of opening a door, window, gate or hatch with such handle arrangement.

In one embodiment, the method may further comprise the steps of receiving, to the mobile device, a pin code from the remote server as a response to the communicated QR code together with identification data, and entering the pin code on a keypad displayed on the display unit.

### BRIEF DESCRIPTION OF THE DRAWINGS

The invention will in the following be described in more detail with reference to the enclosed drawings, wherein:

FIG. 1 shows a handle arrangement according to an embodiment of the present invention;

FIG. 2 shows a handle arrangement according to an embodiment of the present invention;

FIG. 3 shows a handle arrangement according to an embodiment of the present invention;

FIG. 4 shows a handle arrangement according to an embodiment of the present invention;

FIG. 5 shows a schematic block scheme of an embodiment of the present invention;

FIG. 6 shows a flow chart of a method according to an embodiment of the present invention;

FIG. 7 shows a flow chart of a method according to an embodiment of the present invention;

FIG. 8 shows a flow chart of a method according to an embodiment of the present invention; and

FIG. 9 shows a flow chart of a method according to an embodiment of the present invention.

### DESCRIPTION OF EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

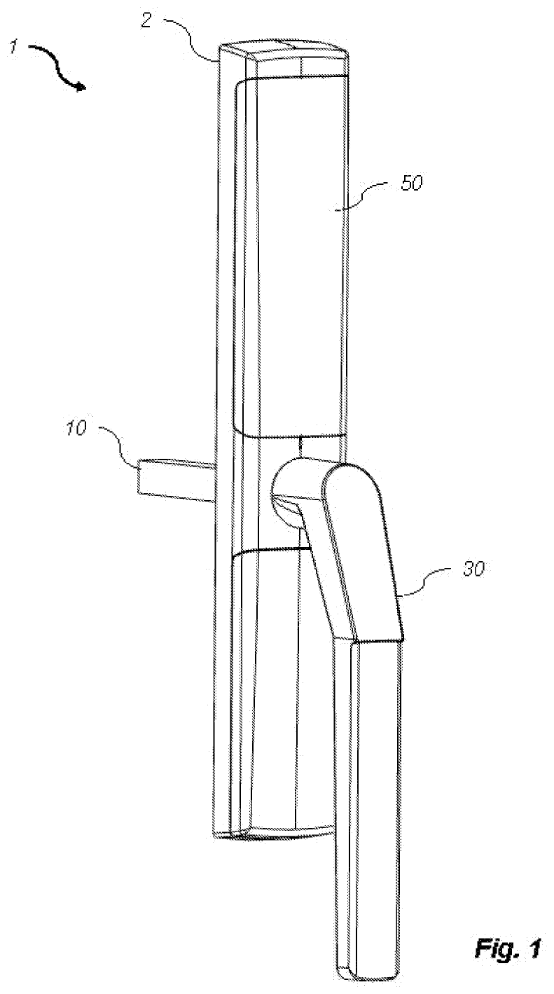

FIG. 1 illustrates a handle arrangement 1 according to an embodiment of the present invention. The handle arrangement 1 comprises a locking mechanism 10 configured to be rotated to unlock a door, window, gate or hatch on which the handle arrangement 1 is arranged relative to a frame. The locking mechanism 10 is rotatable by means of a handle 30. The handle arrangement 1 further comprises a blocking mechanism (not shown in FIG. 1) that can be moved between a blocking state and an unblocking state. In the blocking state operation of the locking mechanism from a locking state to an unlocking state may be prevented by the blocking mechanism 20. Hence, the handle 30 may not be turned to rotate the locking mechanism 10 when the blocking mechanism 20 is in the blocking state. When the blocking mechanism 20 is in the unblocking state the locking mechanism 10 may be rotated by means of the handle 30 and the door, window, gate or hatch may be opened.

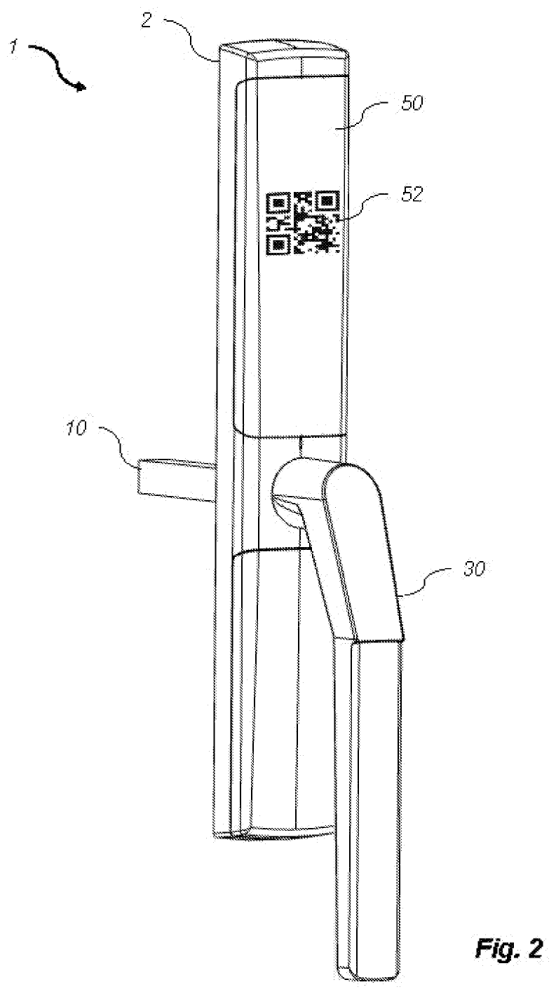

The handle 30 and the locking mechanism 10 are arranged to a housing 2 of the handle arrangement 1. Integrated in the housing is a display unit 50. As seen in FIG. 2, a control unit 40 of the handle arrangement 1 is configured to display a QR code 52 on the display unit.

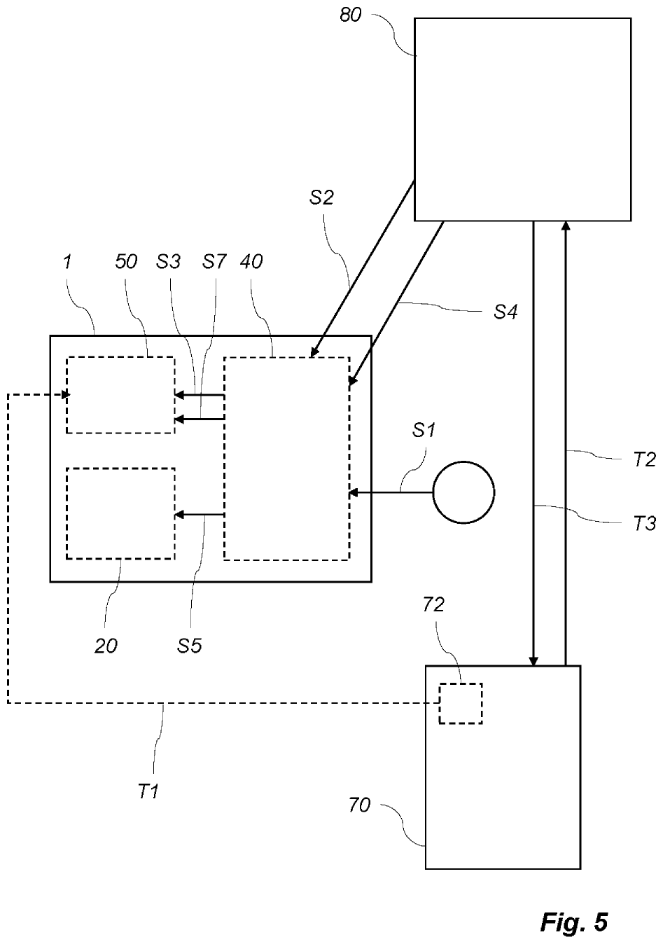

With further reference to FIG. 5, the handle arrangement 1 may be configured to operate as presented below. The control unit 40 is in communicative connection with a remote server 80. The connection may be a wireless connection over a local network and/or via an internet connection. In a step S2, the control unit 40 receives a QR code 52 from the remote server 80. The QR code 52 is unique for the specific handle arrangement 1 and for the time at which it is displayed. The control unit 40 controls the display unit 50 to display S3 the QR code 52. A user may use a mobile device 70 to read T1 the QR code 52. The mobile device 70 comprises means 72 capable of reading a QR code 52. The mobile device 70 may be a mobile phone comprising a camera and a suitable application to read the QR code 52.

The control unit 40 further receives S4 information from the remote server 80 that the user has communicated T2 the read QR code 52 together with an identification of the user, and that the identified user is authorized to open the door, window, gate or hatch.

In one embodiment, the control unit 40 thereby operates S5 the blocking mechanism 20 to be moved from a blocking state to an unblocking state. The user is thereby enabled to open the door, window, gate or hatch.

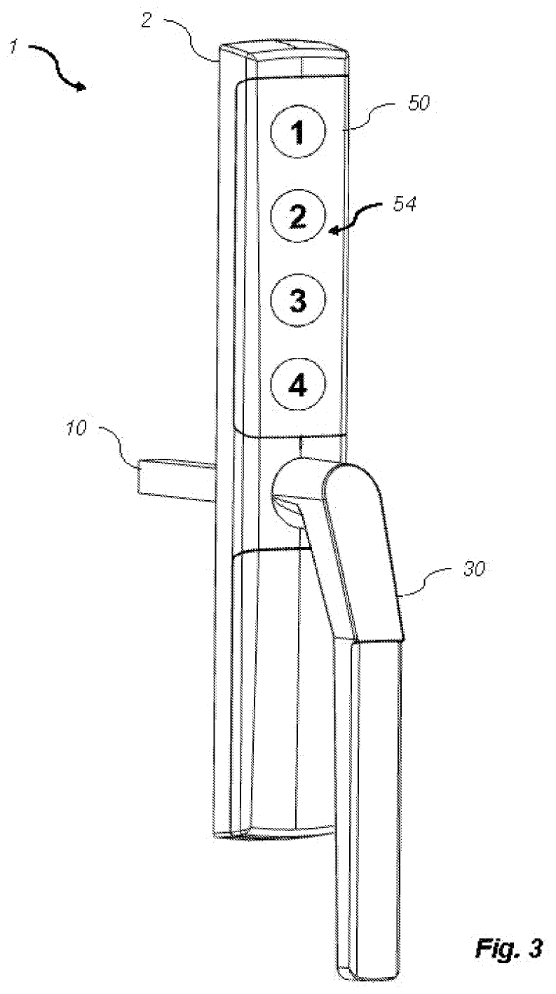

In another embodiment, with further reference to FIG. 3, the control unit 40 displays S7 a keypad 54 on the display unit 50 in response to the received S4 information. Further, in response to the communication T2 of the read QR code and identification information from the mobile device 70 to the remote server 80, the user may have received T3 a pin code from the remote server 80. When the control unit 40 has displayed S7 the keypad 54 on the display unit 50, the user may enter the pin code thereon. In response to the correct pin code have been entered, the control unit 40 then operates S5 the blocking mechanism 20 to be moved from the blocking state to the unblocking state. The control unit 40 may comprise information about the correct pin code, or it may receive information about the correct pin code when receiving S4 information about the authorization of the user's reading of the QR code 52.

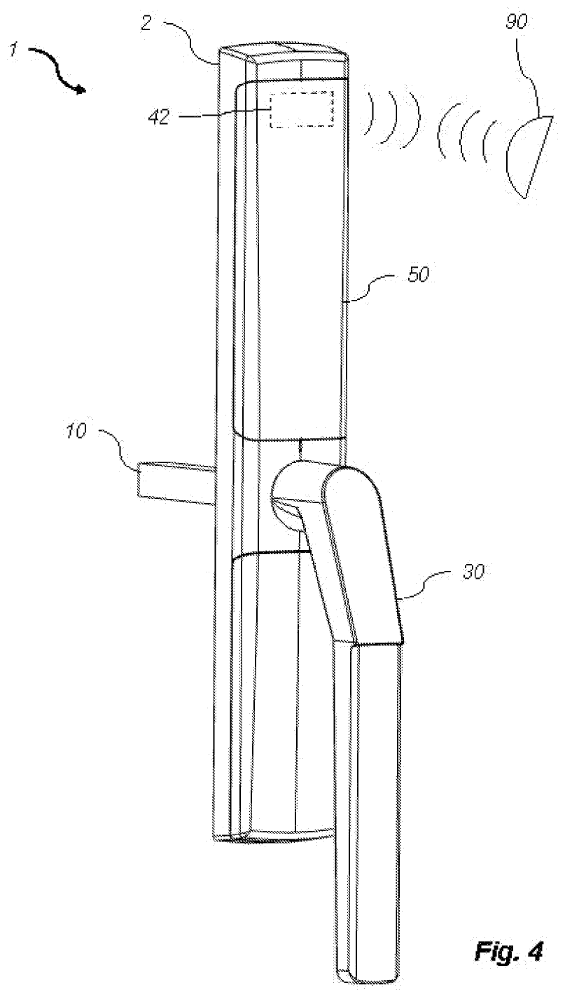

In one embodiment, as an alternative to the second level authorization function of the keypad 54 and pin code, the handle arrangement 1 may comprise a tag reader 42, as illustrated in FIG. 4. When the control unit 40 has received S4 information from the remote server 80 that the user has communicated a read QR code together with an approved identification, the control unit 40 enables a second level authorization function in the form of the tag reader 42 being activated to read a tag 90. The user may then use the tag 90 to further verify authorization for opening the door, window, gate or hatch. Once the control unit 40 has received a reading by the tag reader 42 verifying the user's authorization, the control unit 40 operates S5 the blocking mechanism 20 to the unblocking state. The control unit 40 may comprise information about authorization of the tag 90, or it may receive information about the tag 90 when receiving S4 information about the authorization of the user's reading of the QR code 52.

With further reference to FIG. 5, the control unit's 40 display S3 of a QR code 52 and/or receiving S2 of generated QR code 52 may be initiated by an initiation S1 of an authorization procedure. The initiation S1 may be provided by the user by touching the display unit 50 or a separate initiation button (not shown), or in another way activating the control unit to display S3 the QR code 52.

In any of the embodiments, the QR code 52 may either be generated in the remote server 80, or in the control unit 40. If the QR code is generated in the control unit 40, the step of receiving S2 a generated QR code from the remote server 80 may be avoided. The control unit 40 and the remote server 80 may in such embodiment be synchronized in order to determine the same QR code as the valid one at a specific point of time.

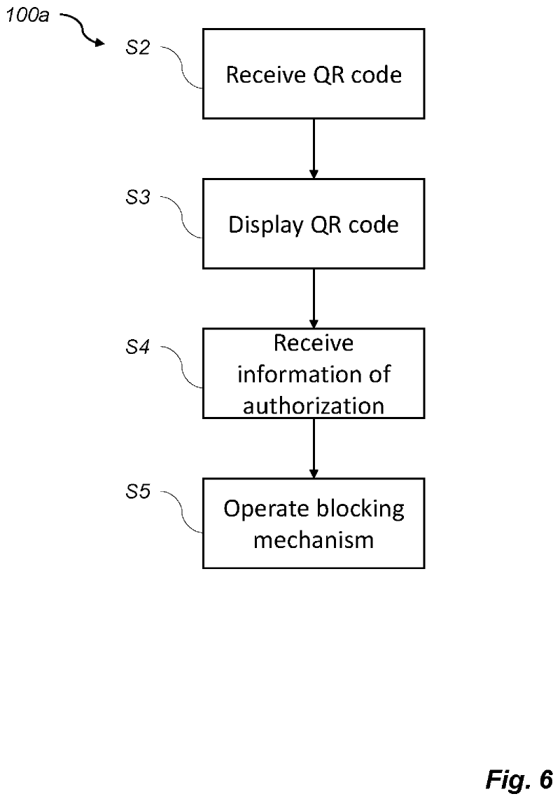

FIG. 6 illustrates a flowchart of the method 100a according to an embodiment of the present invention as discussed above in relation to FIG. 5.

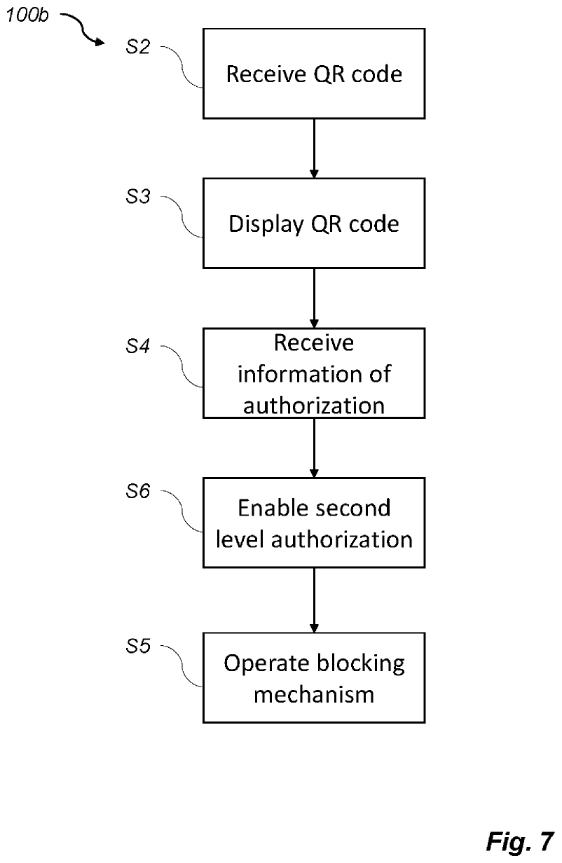

FIG. 7 illustrates a flowchart of the method 100b according to an embodiment comprising the second level authorization function as discussed above. The second level authorization function may be enabled S6 by either display S7 of the keypad and receiving an entered pin code, or the reading of a tag using the tag reader.

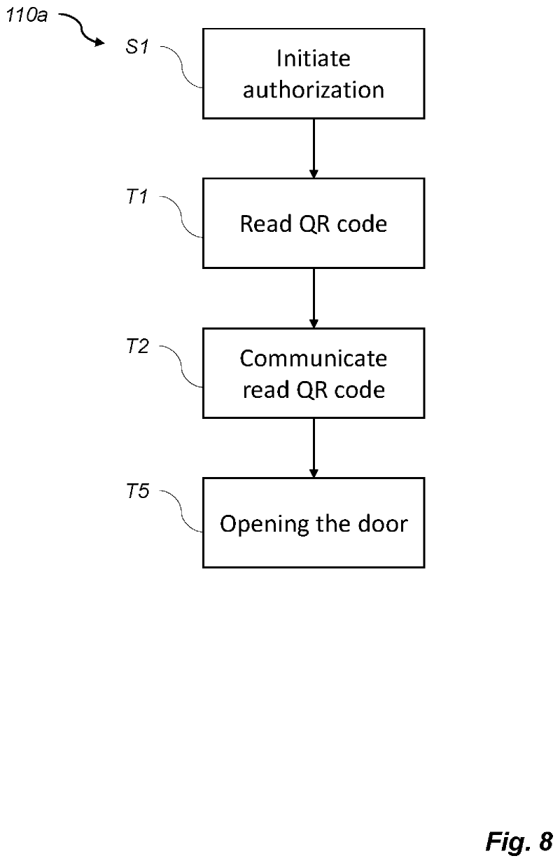

FIG. 8 illustrates a flowchart of a method 110a of opening a door, window, gate or hatch according to an embodiment of the present invention. The method 110a comprises a first step of initiating S1 the authorization procedure. The step of initiating S1 the authorization procedure may in some embodiments be excluded, if the control unit 40 constantly displays a QR code valid at the present point of time. Next, the displayed QR code is read T1 using a mobile device 70, for instance by means of a camera 72 on the mobile device 70. The read QR code 52 is communicated T2 to the remote server 80 together with an identification of the user. The identification information may be prestored in the mobile device 70, for instance in an application in the mobile device 70 dedicated to the authorization procedure of access to doors, windows, gates or hatches having handle arrangements 1 according to the present invention. When the remote server has verified that the identified user is authorized to open the door, window, gate or hatch, such that the blocking mechanism 20 in the handle arrangement 1 has been operated to the unblocking state, the door, window, gate or hatch may be opened T5.

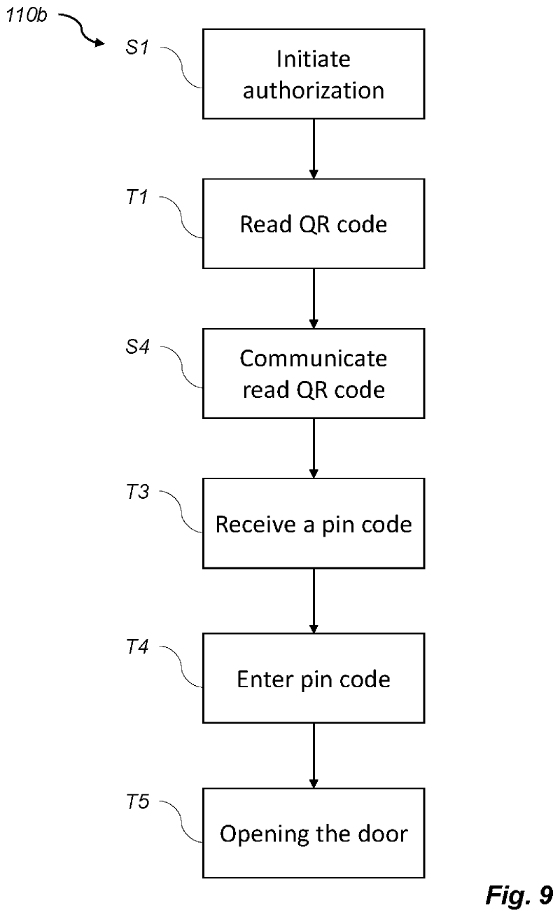

FIG. 9 illustrates a flowchart of a method 110b according to an embodiment. Further to the method 110a in FIG. 8, when the read QR code and identification information has been communicated S4 to the remote server 80, a pin code is received T3 from the remote server 80 to the mobile device 70. Next, the pin code is entered T4 on the display unit 50 of the handle arrangement 1. When it has been verified, either by the remote server 80 or the control unit 40, that the pin code is correct, the door, window, gate or hatch may be opened T5 following the blocking mechanism 20 have been operated to the unblocking state.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. A handle arrangement for arrangement on a door, window, gate or hatch openable relative a frame, the arrangement comprising
a locking mechanism configured to provide, in a locking state, a locking the door, window, gate or hatch to the frame,
a blocking mechanism configured to, in a blocking state, prevent the locking mechanism to be moved from the locking state,
a handle operative by a user and configured to, when operated, move the locking mechanism from the locking state,
characterized in that the handle arrangement further comprises
a control unit communicatively connected to a remote server and capable of controlling the blocking mechanism, and
a display unit controlled by the control unit and configured to display information to a user,
wherein the control unit is configured to
display a QR code on the display unit for a user to read by means of a mobile device capable of reading a QR code, wherein the QR code is unique for the handle arrangement and the time period during which the QR code is displayed,
receive, from a remote server, information that the user has communicated, to the remote server, a reading of the displayed QR code together with an identification of the user, and that the identified user is authorized to open the door, window, gate or hatch, and
in response to the received information from the remote server, enable a second level authorization function for the user to verify its authorization, and if access is granted, operate the blocking mechanism from the blocking state to an unblocking state, thereby enabling opening of the door, window, gate or hatch by means of the handle.

2. The handle arrangement according to claim 1, wherein the step of enabling a second level authorization function comprises displaying a keypad on the display unit for the user to enter a pin code, and when the correct pin code is entered, operating the blocking mechanism from the blocking state to an unblocking state, thereby enabling opening of the door, window, gate or hatch by means of the handle.

3. The handle arrangement according to claim 1, wherein the handle arrangement further comprises a tag reader, and the step of enabling a second level authorization function comprises the step of the control unit activating the tag reader, and when tag is read authorizing the user, operating the blocking mechanism from the blocking state to an unblocking state, thereby enabling opening of the door, window, gate or hatch by means of the handle.

4. The handle arrangement according to claim 1, wherein the QR code is generated on the remote server, and the control unit is further configured to receive the QR code from the remote server and then display the received QR code on the display unit.

5. The handle arrangement according to claim 1, wherein the handle arrangement further comprises a housing in which the blocking mechanism and the control unit are mounted, in which the display unit is integrated, and to which the handle is arranged.

6. The handle arrangement according to claim 1, wherein the display unit is a touch-sensitive display.

7. The handle arrangement according to claim 1, wherein the control unit is configured to display the QR code on the display unit as a response to an initiation of an authorization procedure.

8. The handle arrangement according to claim 7, wherein the display unit is a touch-sensitive display, and the initiation is provided by a user touching the display unit.

9. The handle arrangement according to claim 7, wherein the handle arrangement further comprises an authentication activation button, and wherein an activation of said button provides said initiation of the authorization procedure.

10. The handle arrangement according to claim 7, wherein the QR code is generated as a response to the initiation of an authorization procedure.

11. The handle arrangement according to claim 1, wherein the blocking mechanism further comprises an electric motor configured to operate the blocking mechanism between the blocking state and the unblocking state, and wherein the control unit is configured to control the electric motor to operate the blocking mechanism.

12. The handle arrangement according to claim 10, wherein after said predetermined time period, the control unit is configured to either stop the displaying of the QR code, or to replace the QR code with a new QR code that is valid for authorization of a user during a new time period starting from the displaying of the new QR code.

13. A method of opening a door, window, gate or hatch provided with a handle arrangement according to any of the preceding claims, the method comprising the steps of
reading a QR code displayed on the display unit of the handle arrangement by means of a mobile device capable of reading a QR code,
communicating the read QR code to a remote server together with identification data of the user,
in response to the remote server verified that the identified user is authorized to open the door, window, gate or hatch and the QR code has been read, enable a second level authorization function for the user to verify its authorization,
in response to a verification of the second level authorization function that the user is authorized, operate the blocking mechanism from the blocking state to an unblocking state, thereby enabling opening of the door, window, gate or hatch by means of the handle such that the blocking mechanism is operated from the blocking state to an unblocking state.

14. The method according to claim 13, wherein
after communicating the read QR code to a remote server, receiving, to the mobile device, a pin code from the remote server as a response to the communicated QR code together with identification data,
the step of enabling a second level authorization function comprises displaying a keypad on the display unit, and
entering the pin code on the keypad displayed on the display unit to verify the user's authorization in the second level authorization function.
